(19) United States
(12) Patent Application Publication
(10) Pub. No.: US 2005/0280925 A1
(43) Pub. Date: Dec. 22, 2005

(54) Magnetic recording and reading apparatus with means for preventing noise

(75) Inventors: Myoung-joon Kim, Suwon-si (KR); Dong-seok Lee, Seoul (KR); Byeng-bae Park, Ansan-si (KR); Jae-hoon Sim, Suwon-si (KR); Seung-woo Lee, Suwon-si (KR); Hyeong-seok Choi, Suwon-si (KR); Jeong-hyeob Oh, Anyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/134,316

(22) Filed: May 23, 2005

(30) Foreign Application Priority Data
Jun. 16, 2004 (KR) 2004-44288

(51) Int. Cl. G11B 15/00

(52) U.S. Cl. 360/84

(57) ABSTRACT

A magnetic recording and reading apparatus includes a noise preventing member provided to at least one of a deck and a holder to cover an upper side of a head drum. Noise generated by the contact between the head drum and the magnetic tape is substantially prevented from being transmitted outside of the magnetic recording and reading apparatus and to a microphone in recording operation, thereby improving the quality of recorded sound.

### CROSS-REFERENCE TO RELATED APPLICATIONS

This application claims the benefit under 35 U.S.C. § 119(a) from Korean Patent Application No. 2004-44288, filed on Jun. 16, 2004, the entire contents of which are hereby incorporated by reference.

### BACKGROUND OF THE INVENTION

1. Field of the Invention

The present invention relates to a magnetic recording and reading apparatus. More particularly, the present invention relates to a magnetic recording and reading apparatus with an improved structure of preventing noise from being transmitted to the outside of the apparatus.

2. Description of the Related Art

Generally, a magnetic recording and reading apparatus is provided with a head drum on which a head chip is mounted. The head chip mounted on the head drum contacts a magnetic tape to record or read information.

FIG. 1 is a schematic perspective view of a conventional magnetic recording/reading apparatus. Referring to FIG. 1, the magnetic recording and reading apparatus includes a deck 30 in which various components are mounted so as to record and read information on and from a magnetic tape. A head drum 10 is disposed in the deck 30 to be rotatably contacted with the magnetic tape and to record and read information. A guide pole 20 is disposed in the deck 30 to guide the magnetic tape to be contacted with the head drum 10. A holder 40 is movably disposed in the deck 30 so that a user can insert or withdraw the magnetic tape into and from the deck 30.

A holder cover 44 is disposed at an upper portion of the holder 40. A holder shutter 48 is disposed at an end of the holder cover 44 to prevent the user's finger from being shut into the holder cover 44.

If the user inserts the magnetic tape into the holder 40 and then pushes down the holder cover 44 disposed at the upper portion of the holder 40, the holder 40 is locked in the deck 30 and the magnetic tape is safely settled in the deck 30. Then, the magnetic tape is withdrawn from a cartridge and guided by the guide pole 20 and contacted with the head chip 14 disposed at the head drum 10. The head chip 14 reads recorded information or records information. During this process, the magnetic tape is contacted with the rotating head chip 14, thereby generating noise. The noise is transmitted to the outside of the magnetic recording and reading apparatus, and this becomes a source of great annoyance to the user. Furthermore, when recording the information on the magnetic tape, the noise is transmitted to a microphone. Therefore, the noise is included in the information recorded on the magnetic tape, thereby deteriorating the quality of recorded sound.

Accordingly, a need exists for a magnetic recording and reading apparatus that substantially eliminates noise produced while engaging the magnetic tape with the head drum.

### SUMMARY OF THE INVENTION

An object of the present invention is to provide a magnetic recording and reading apparatus with an improved structure of substantially preventing noise generated from a head drum.

A magnetic recording and reading apparatus includes a deck in which a magnetic tape is settled, a head drum disposed on the deck to record or read information, a holder movably disposed at the deck to settle the magnetic tape in the deck, and a noise preventing member attached to at least one of the deck and the holder to cover an upper side of the head drum.

The noise preventing member may be integrally formed with a holder cover disposed at an upper side of the holder.

The noise preventing member may be integrally formed with a holder shutter disposed at the upper side of the holder.

The noise preventing member may be disposed to cover only a contacting portion of the head drum that the magnetic tape contacts.

The noise preventing member may further include a blocking shield disposed on a course between a microphone and the head drum to substantially prevent the noise from being transmitted to the microphone.

The noise preventing member may further include an acoustic absorption member disposed at the upper side of the head drum.

Other objects, advantages and salient features of the invention will become apparent from the following detailed description, which, taken in conjunction with the annexed drawings, discloses exemplary embodiments of the invention.

### BRIEF DESCRIPTION OF THE DRAWINGS

The above aspects and features of the present invention will be more apparent by describing certain embodiments of the present invention with reference to the accompanying drawings, in which:

FIG. 1 is a schematic perspective view of a conventional magnetic recording and reading apparatus;

FIG. 2 is a schematic perspective view of a magnetic recording and reading apparatus according to an exemplary embodiment of the present invention;

FIG. 3 is a schematic perspective view of the magnetic recording and reading apparatus according to another exemplary embodiment of the present invention;

FIG. 4 is a schematic perspective view of the magnetic recording and reading apparatus according to another exemplary embodiment of the present invention;

FIG. 5 is a schematic perspective view of the magnetic recording and reading apparatus according to still another exemplary embodiment of the present invention; and

FIG. 6 is a lateral cross-sectional view of a noise preventing member of the magnetic recording and reading apparatus according to yet another exemplary embodiment of the present invention.

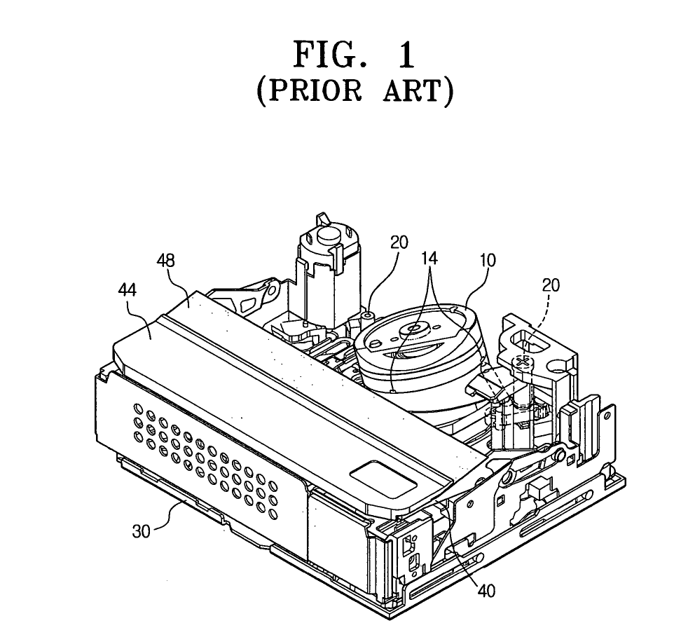

Throughout the drawings, like reference numerals will be understood to refer to like parts, components and structures.

### DETAILED DESCRIPTION OF EXEMPLARY EMBODIMENTS

Hereinafter, an embodiment of the present invention will be described in detail with reference to the accompanying drawing figures.

The matters defined in the description, such as a detailed construction and elements thereof, are provided to assist in a comprehensive understanding of the invention. Thus, it is apparent that the present invention may be carried out without those defined matters. Also, well-known functions or constructions are omitted to provide a clear and concise description of exemplary embodiments of the present invention.

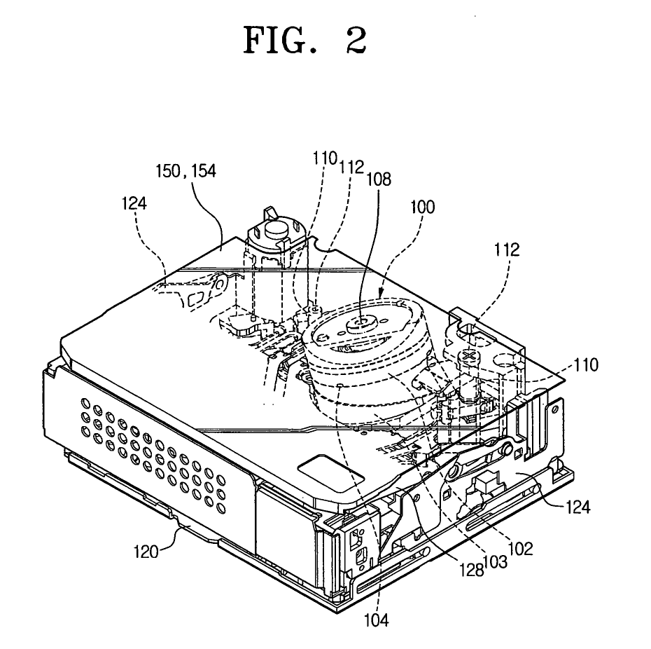

FIG. 2 is a schematic perspective view of a magnetic recording and reading apparatus according to an exemparly embodiment of the present invention.

Referring to FIG. 2, a magnetic recording and reading apparatus according to an embodiment of the present invention includes a deck 120 in which various components are mounted to record and read information on and from a magnetic tape. A head drum 100 is disposed in the deck 120 to record and read the information on and from the magnetic tape. A guide pole 110 is disposed in the deck 120 to guide the magnetic tape to the head drum 100. A holder 128 is disposed in the deck 120 to be vertically movable and safely settle the magnetic tape in the deck 120. A noise preventing member 150 is disposed at the holder 128 to cover an upper side of the holder 128.

In the deck 120, there are disposed various components for driving the magnetic recording and reading apparatus. The deck 120 is formed with sidewalls 124 between which the magnetic tape is settled.

The head drum 100 is fixed on the deck 120 to be inclined at a desired angle by a fastener, such as a bolt. The head drum 100 includes a rotational drum 102 rotated on a rotational shaft 108, and a fixed drum 103 fixed to the rotational shaft 108 and the deck 120. A head chip 104 is disposed at the rotational drum 102 to protrude from an outer surface of the rotational drum 102 and to contact the magnetic tape. The rotational drum 102 is rotated by a desired signal from a control portion (not shown). Due to the rotation of the rotational drum 102, the head chip 104 fixed to the rotational drum 102 and protruding from the outer surface thereof contacts the magnetic tape while being rotated. Due to the contact between the magnetic tape and the head chip 104, information may be recorded on the magnetic tape or information recorded on the magnetic tape maybe read.

The guide pole 110 guides the magnetic tape to stably contact the head drum 100. The guide pole 110 is formed with a groove 112 at a top portion thereof so that a height of the guide pole 110 may be adjusted by a tool, such as a screwdriver.

The holder 128 is disposed on the deck 120 to be vertically movable. When a user withdraws or inserts the magnetic tape, the holder 128 locked with the deck 120 is released by a signal from the control portion, and then moved to an upper side of the deck 120 by a spring (not shown) disposed at the deck 120 and the holder 128. After inserting or withdrawing the magnetic tape into and from the moved holder 128, the user pushes down the holder 128 so that the holder 128 is moved downward and locked with the deck 120. Since the moving structure and the locking structure of the holder 128 are well known, a description thereof is omitted.

The noise preventing member 150 is disposed at an upper side of the holder 128 to extend to the upper side of the head drum 100, thereby covering the head drum 100. However, since the guide pole 110 has to be capable of being controlled from outside, the noise preventing member 150 is disposed to be opened at an upper side of the guide pole 110 (that is, a recess or opening in the noise preventing member provides access to the guide pole). An existing holder cover 154, which extends to cover the upper side of the head drum 100, is used as the noise preventing member 150. The holder cover 154 is fixedly coupled to the holder 128 by a hook coupling means. Since the hook coupling means is well known in this technical field, a description thereof is omitted. Meanwhile, since the noise preventing member 150 is disposed to cover the upper side of the head drum 100, it substantially prevents the noise generated when the magnetic tape contacts the head chip 104 mounted on the outer surface of the rotational drum 102 of the head drum 100 to be transmitted outside of the magnetic recording and reading apparatus. Further, the noise preventing member 150 may be hooked and bonded to the sidewall 124 of the deck 120.

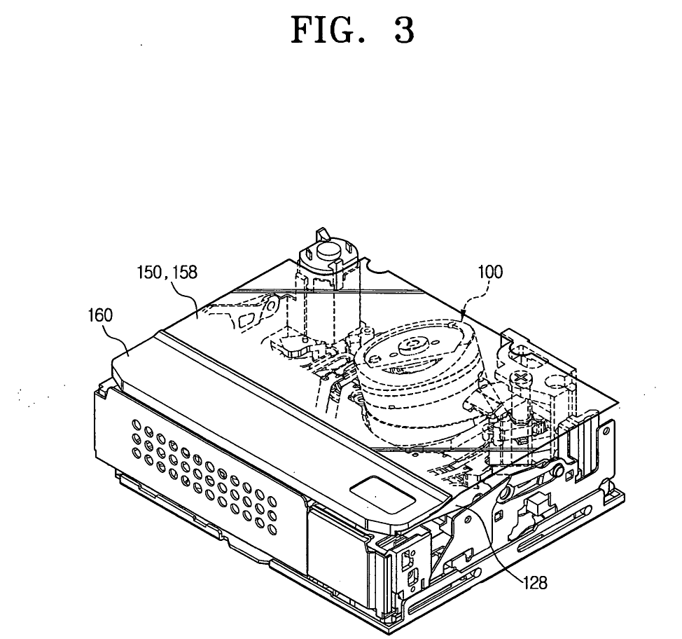

FIG. 3 is a schematic perspective view of the magnetic recording and reading apparatus according to another embodiment of the present invention.

Referring to FIG. 3, the magnetic recording and reading apparatus according to another embodiment of the present invention has a holder shutter 158 disposed at an upper side of the holder 128 that extends to an upper side of the head drum 100. The holder shutter 158 is bonded to a holder cover 160, which is hooked to the holder 128 to cover an upper side of the holder 128. The holder shutter 158 was disposed at the upper side of the holder 128 to prevent a user's finger from being shut when the user withdrew or inserted the magnetic tape. However, in the second embodiment of the present invention, the holder shutter 158 is extended to cover the upper side of the head drum 100, and thus used as the noise preventing member 150.

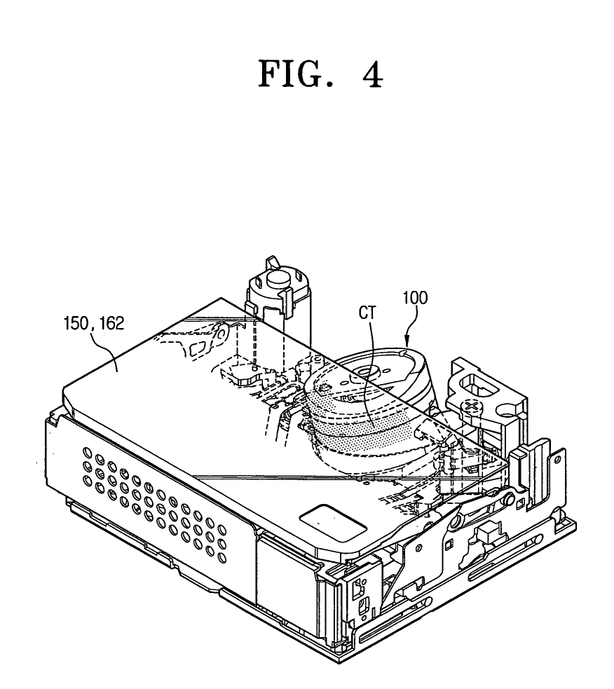

FIG. 4 is a schematic perspective view of the magnetic recording and reading apparatus according to another embodiment of the present invention.

Referring to FIG. 4, a holder cover 162 forms the noise preventing member, which extends only to an upper side of a contacting portion CT of the head drum 100 that the magnetic tape contacts. This structure substantially prevents the noise of the head drum 100 from being transmitted to the outside and also reduces a cost of the holder cover 162.

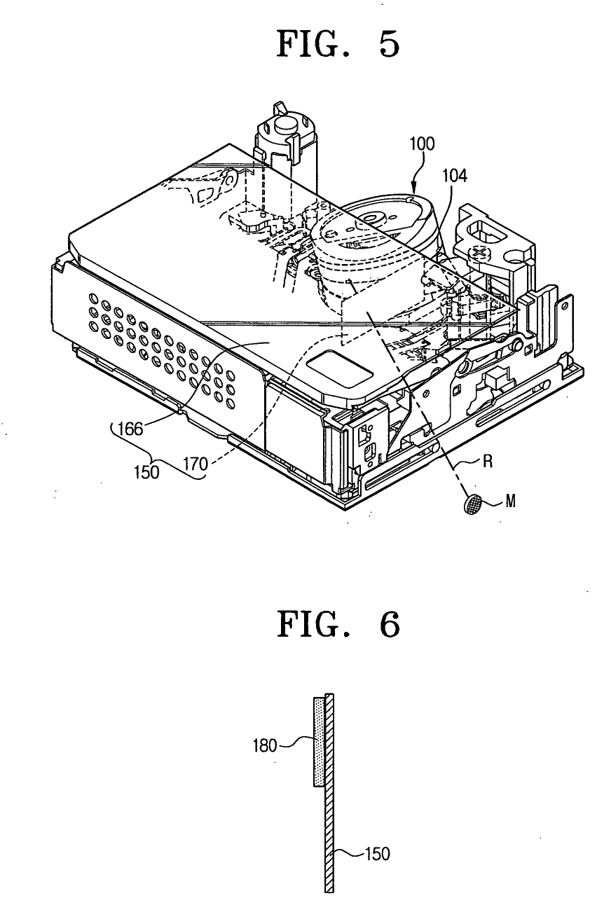

FIG. 5 is a schematic perspective view of the magnetic recording and reading apparatus according to a yet another embodiment of the present invention.

Referring to FIG. 5, the noise preventing member 150 of the magnetic recording and reading apparatus according to a yet another embodiment of the present invention includes a blocking shield 170 extending downwardly from a holder cover 166 on a course R between a microphone M and the head drum. This substantially prevents noise generated between the head chip 104 and the magnetic tape from being input to the microphone M. The noise generated between the head chip 104 and the magnetic tape is substantially prevented from being input to the microphone M, thereby improving the quality of recorded sound.

FIG. 6 is a lateral cross-sectional view of a noise preventing member of the magnetic recording and reading apparatus according to an exemplary embodiment of the present invention.

Referring to FIG. 6, the noise preventing member 150 of the magnetic recording and reading apparatus according to another exemplary embodiment of the present invention includes an acoustic absorption member 180 disposed at the upper side of the head drum 100 (referring to FIG. 5). The acoustic absorption member 180 has a various patterned-surface, such as embossing, etc., to effectively absorb the noise. Since the acoustic absorption member 180 is well known, a description of a structure thereof is omitted. In the first to fifth embodiments, the acoustic absorption member 180 is attached to a lower surface of the holder cover 154, 160, 162, 166 or the holder shutter 158 as the noise preventing member 150.

According to the magnetic recording and reading apparatus according to an exemplary embodiment of the present invention, the noise preventing member is provided to cover the upper side of the head drum to substantially prevent noise generated between the head drum and the magnetic tape from being transmitted outside of the magnetic recording and reading apparatus, thereby improving a performance of the magnetic recording and reading apparatus.

Further, when recording information on the magnetic tape, the noise generated between the head drum and the magnetic tape is substantially prevented from being transmitted to the outside of the magnetic recording and reading apparatus, thereby improving the quality of recorded sound.

While the invention has been shown and described with reference to certain embodiments thereof, it will be understood by those skilled in the art that various changes in form and details may be made therein without departing from the spirit and scope of the invention as defined by the appended claims.

1. A magnetic recording and reading apparatus, comprising:
a deck adapted to receive a magnetic tape;
a head drum disposed on the deck to record or read information on and from the magnetic tape;
a holder movably disposed and attached to the deck; and
a noise preventing member attached to at least one of the deck and the holder to cover an upper side of the head drum.

2. The apparatus as claimed in claim 1, wherein
the noise preventing member is integrally formed with a holder cover disposed at an upper side of the holder.

3. The apparatus as claimed in claim 1, wherein
the noise preventing member is integrally formed with a holder shutter disposed at an upper side of the holder.

4. The apparatus as claimed in claim 1, wherein
the noise preventing member is disposed to cover only a contacting portion of the head drum that contacts the magnetic tape.

5. The apparatus as claimed in claim 1, wherein
a blocking shield is disposed between a microphone and the head drum to substantially prevent noise from being transmitted to the microphone.

6. The apparatus as claimed in claim 5, wherein
an acoustic absorption member is disposed on the noise preventing member at the upper side of the head drum.

7. The apparatus as claimed in claim 1, wherein
recesses in the noise preventing member provide access to guide poles disposed on the deck.

8. The apparatus as claimed in claim 6, wherein
the acoustic absorption member is disposed on a lower surface of the noise preventing member.

9. A magnetic recording and reading apparatus, comprising:
a deck adapted to receive a magnetic tape;
a head drum disposed on the deck to record or read information on and from the magnetic tape;
at least one guide pole disposed on the deck to facilitate contacting the magnetic tape with the head drum;
a holder movably attached to the deck;
a noise preventing member attached to at least one of the deck and the holder to cover an upper side of the head drum that contacts the magnetic tape; and
at least one opening in the noise preventing member to provide access to the at least one guide pole.

10. The apparatus as claimed in claim 9, wherein
the noise preventing member is integrally formed with a holder cover disposed at an upper side of the holder.

11. The apparatus as claimed in claim 9, wherein
the noise preventing member is integrally formed with a holder shutter disposed at an upper side of the holder.

12. The apparatus as claimed in claim 9, wherein
a blocking shield is disposed between a microphone and the head drum to substantially prevent noise from being transmitted to the microphone.

13. The apparatus as claimed in claim 9, wherein
an acoustic absorption member is disposed on the noise preventing member at the upper side of the head drum.

14. The apparatus as claimed in claim 13, wherein
the acoustic absorption member is disposed on a lower surface of the noise preventing member.

15. A magnetic recording and reading apparatus, comprising:
a deck adapted to receive a magnetic tape;
a head drum disposed on the deck to record or read information on and from the magnetic tape;
a holder movably attached to the deck; and
a noise preventing member attached to at least one of the deck and the holder to cover a contacting portion of the head drum that contacts the magnetic tape.

16. The apparatus as claimed in claim 15, wherein
the noise preventing member is integrally formed with a holder cover disposed at an upper side of the holder.

17. The apparatus as claimed in claim 15, wherein
the noise preventing member is integrally formed with a holder shutter disposed at an upper side of the holder.

18. The apparatus as claimed in claim 15, wherein
a blocking shield is disposed between a microphone and the head drum to substantially prevent noise from being transmitted to the microphone.

19. The apparatus as claimed in claim 15, wherein
an acoustic absorption member is disposed on the noise preventing member at the upper side of the head drum.

20. The apparatus as claimed in claim 19, wherein
the acoustic absorption member is disposed on a lower surface of the noise preventing member.
